(19) United States
(12) Patent Application Publication
(10) Pub. No.: US 2024/0184789 A1
(43) Pub. Date: Jun. 6, 2024

(54) CREATING A QUERY TEMPLATE OPTIMIZED FOR BOTH RECALL AND PRECISION

(71) Applicant: Microsoft Technology Licensing, LLC, Redmond, WA (US)

(72) Inventors: George J. Pearman, Menlo Park, CA (US); Michael Chernyak, Los Gatos, CA (US); Jingwei Wu, Foster City, CA (US); Scott A. Banachowski, Mountain View, CA (US)

(21) Appl. No.: 18/076,057

(22) Filed: Dec. 6, 2022

(51) Int. Cl. G06F 16/2457; G06F 16/22; G06F 16/2453

(52) U.S. Cl. CPC G06F 16/24578; G06F 16/22; G06F 16/24535

(57) ABSTRACT

Methods, systems, and computer programs are presented for creating a query template optimized for recall and precision to be used in database searches. One method includes operations for identifying a training set for training a model, generating subqueries based on features associated with the training set, and performing iterations to create a query template. Each iteration comprises performing a search for each subquery based on a disjunction of the subquery and the query template, calculating a precision of each subquery, and adding the subquery with the highest precision to the query template. The method further includes operations for receiving a search query from a device of a first user, customizing the query template based on the search query and information of the first user to obtain a search selection query, and performing a search utilizing the search selection query. The search results are presented on a display.

### TECHNICAL FIELD

The subject matter disclosed herein generally relates to methods, systems, machine-readable storage media, and programs for creating a query template, for searching and recommending documents, optimized for both precision and recall.

### BACKGROUND

Information-retrieval systems, such as online marketplaces, news feeds, and search engines, facilitate information discovery by searching items and ranking retrieved items based on predicted relevance, e.g., likelihood of interaction of a user with the retrieved item (e.g., a click, a share). Conventional search queries, such as in a job search embodiment, can encounter major ambiguities based on the terms or types of terms being searched. When dealing with millions of items, the goal of a search is to retrieve some number of search results, as the number of total results may be too large and the user typically only cares about a few good results (e.g., finding a good job listing). Thus, there is a tradeoff in search computations between having good precision in order to retrieve only good results (without including undesired results) and having good recall in order to retrieve all the good results from the corpus.

Search is one of the most intensely studied problems in software engineering. It brings together information retrieval, machine learning, distributed systems, and other fundamental areas of computer science. In computer connection networks, users employ search products to find people, jobs, companies, groups, and other professional content. Connection networks include online systems or online services for users of the connection network to search and receive recommendations for job postings or job descriptions based on input received from a user. A user may provide input to the connection network, which calculates a quantitative measurement of a likelihood that a user will find a job posting relevant for their job search.

### BRIEF DESCRIPTION OF THE DRAWINGS

The present disclosure will be apparent from the following more particular description of examples of embodiments of the technology, as illustrated in the accompanying drawings. The drawings are not necessarily to scale, emphasis instead being placed upon illustrating embodiments of the present disclosure. In the drawings, like numerals may describe similar components in different views. Like numerals having different letter suffixes may represent different instances of similar components. The drawings illustrate generally, by way of example, but not by way of limitation, various embodiments discussed in the present document.

Various embodiments in accordance with the present disclosure will be described with reference to the drawings, in which:

FIG. 1 illustrates the search process, according to some example embodiments;

FIG. 2 is a high-level diagram of a system for searching using a search index, according to some example embodiments;

FIG. 3 is a screenshot of a user's profile, according to some example embodiments;

FIG. 4 illustrates a block diagram illustrating the generation of an inverted index, according to some example embodiments;

FIG. 5 is a chart depicting the types of documents retrieved in a search and used for calculating precision and recall, according to some example embodiments;

FIG. 6 is a diagram for illustrating the training process to create a query template, according to example embodiments;

FIG. 7 is a block diagram depicting a training phase and a classification phase to utilize the query template for user searches, according to some example embodiments;

FIG. 8 illustrates a flowchart of a method for creating the query template, according to some example embodiments;

FIG. 9 is a flowchart of a method for creating a query template optimized for recall and precision to be used in database searches, according to some example embodiments;

FIG. 10 illustrates the training and use of a machine-learning model, according to some example embodiments;

FIG. 11 is a block diagram illustrating a networked system, according to some example embodiments, including a networking server, illustrating an example embodiment; and

FIG. 12 is a block diagram illustrating an example of a machine 1200 upon or by which one or more example process embodiments described herein may be implemented or controlled.

### DETAILED DESCRIPTION

Example methods, systems, and computer programs are directed to creating a query template optimized for recall and precision to be used in database searches. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

### Overview

Example embodiments of the present disclosure include a training process for generating a query template that is optimized for precision and recall. Developers define features to be used as input for the training, and the trainer generates a query template. When a search request is received, the query template is used to generate a search selection query by filling the query template with values based on a search request and information about the user associated with the request. The search selection query is then used to search the database, which may include searching using an inverted index.

Example embodiments disclosed herein provide technical solutions and improvements to the relevant technology related to search services or other target selection approaches, such as other search selection models. Such technical solutions include the ability to calculate precision and recall during the model training process. The training phase leverages a search index to execute real search queries during the training process to evaluate the training set in order to select the optimal clauses that may be included in the query template. Unlike traditional artificial intelligence (AI) and/or machine learning (ML) search techniques that include estimates or simulations of how a search will work during a classification phase, example embodiments employ search indexes during the training phase to train the model.

Current typical technologies would require decades worth of computational time and computational resources to calculate an appropriate search selection query because determining an optimal recall query and determining an optimal precision query creates a combinatorial problem that is computationally difficult to solve. Such a combinatorial problem consists in finding, provided a finite collection of objects and set of constraints, an object of the collection that satisfies all constraints. In such typical or traditional solutions, training, using supervised learning, a model includes using a training set, which includes a list of positive example objects and a set of negative example objects. For example, an online system or service that includes a connection network with 800 million users, providing, on average, 20 million job postings (or job descriptions), typical search systems would contain up to 20 million rows in their training set for each of the 800 million users. An existing training set (e.g., in a spreadsheet) would then contain millions of columns where each column provides a label related to every feature (e.g., user ID, user title, etc.), which would create a computationally complex combinatorial problem that could take about 18 years to search.

Traditional AI models are trained using sample data which represents a part of an entire document corpus due to computational limitations and size complexity. For example, an existing solution might use a table to describe the training data for a model, where each row represents a document/query pair and each column would correspond to a dimension that describes the match or lack of match. With such traditional approaches, it is not feasible to calculate the precision for a group of queries, because each query would require tens of millions of rows, so there is data for each query relative to every document in the index, where the size of the training data would be a number of queries multiplied by the number of documents.

Current relevant technologies for query-expansion processes for most search applications rely on hand-crafted rules to create a query selection model, where using such hand-crafted rules includes challenges such as, for example, (1) motivation behind a rule can change or get lost over time, (2) adding new rules has a slow feedback cycle of A/B testing in production, and (3) rules interact with each other in unpredictable ways. For example, current solutions for query expansion to improve precision without degrading recall, require creating augmented terms and artificially expanding an initial query by conjunctions of the terms, where the augmented terms are falsely weighted or assigned higher weights than other terms based on a user's preference.

However, example embodiments of the present disclosure improve upon and overcome such current technical problems by training a model to perform searches by leveraging an entire document set (corpus) represented in a more storage-and-compute efficient manner by using real search indexes to calculate precision and recall of the possible queries during the training phase, thereby reducing the search space to make training feasible. By using a real search index instead of representing the data as a table, example embodiments perform real searches against the real search index to locate which documents match which query for each iteration of the model during training, wherein the size of the training data is the number of queries plus the number of documents.

Further, example embodiments of the present disclosure overcome these combinatorial problems by using a query structure and a search index to minimize an amount of search space, thereby improving the functioning of a computer system by improving resource consumption, latency, and scalability in computer systems on which example embodiments of the present disclosure are run. Further example embodiments provide techniques on how the query structure is used to reduce the complexity as well as the source space in the training of the model. Thus, example embodiments create query templates, where the output of the machine learning model is a search selection query to be employed during classification.

Such improvements enable example embodiments of the training infrastructure to confirm that results provided to a user during the classification phase will reflect what occurred during the training phase, and vice versa. In one example embodiment of the present disclosure, a query rewriting process includes defining one or more search selection rules as one or more features and training a search selection model using the defined one or more features. Then, a search index is used during the model training process to calculate both the precision and the recall of the one or more possible queries to include in the query template. Finally, it includes applying the query template obtained during training for searching.

Unlike traditional search and recommendation systems, which solely focus on estimating how relevant an item is for a given query, example embodiments of the present training infrastructure include a search selection model that generates a search selection query that includes a concise method of representing complicated query logic that is suitable for many use cases. In some example embodiments, the search selection query represents business logic that is to be applied to search queries searching an index.

Thus, example embodiments of the present disclosure solve the technical problem of search selection relevance, where a search selection model translates the search keywords entered as input by a user into a search selection query by filling in the query template with the required values.

### Detailed Embodiments

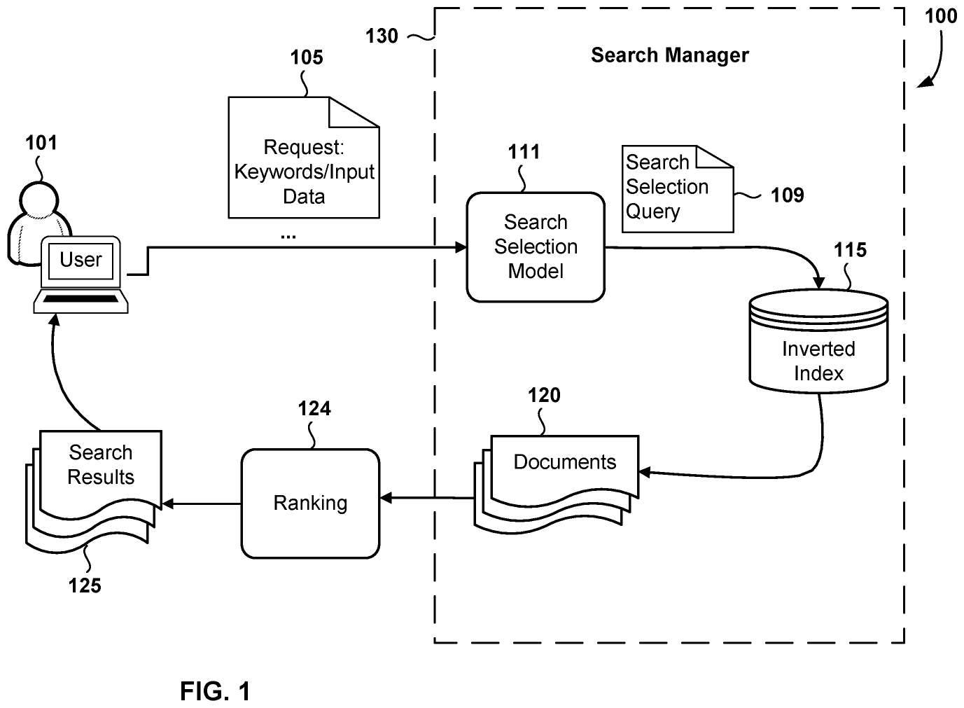

FIG. 1 illustrates a block diagram 100 depicting a search manager 130 for searching documents utilizing an inverted index 115, according to some example embodiments. These example embodiments can be used in a variety of search cases, such as searches for ads to be presented on a user's feed, suggestions of People-You-May-Know (PYMK) to the user, job-posting recommendations, possible candidates to recruit for a job posting, news items on a user feed, etc. However, for simplicity, the detailed embodiments will describe examples for searching job postings for a user, but the same principles may be used for other types of searches.

In some example embodiments, the search manager 130 generates a set of one or more documents 120, where each document is a job posting to be ranked and recommended as search results 125 to the user 101. The search selection model 111 receives as input the incoming request 105 and outputs the search selection query 109 using, at least, features from the incoming request 105. The search selection query 109 is then used to search the inverted index 115.

In some example embodiments, the inverted index 115 is a data structure configured for storing a mapping of content (e.g., terms, words, numbers, etc.) to the location of the documents that include that content. For example, the inverted index 115 may include a HashMap-like data structure that indicates in which documents a word is located. The purpose of the inverted index 115 is to enable fast full-text searches at a cost of increased processing when a document is added to the database. In some example embodiments, the inverted index 115 may be part of the database, rather than a separate data structure. There are two main variants of inverted indexes: a record-level inverted index (or inverted file index or just inverted file) that contains a list of references to documents for each word, and a word-level inverted index (or full inverted index or inverted list) that additionally contains the positions of each word within a document.

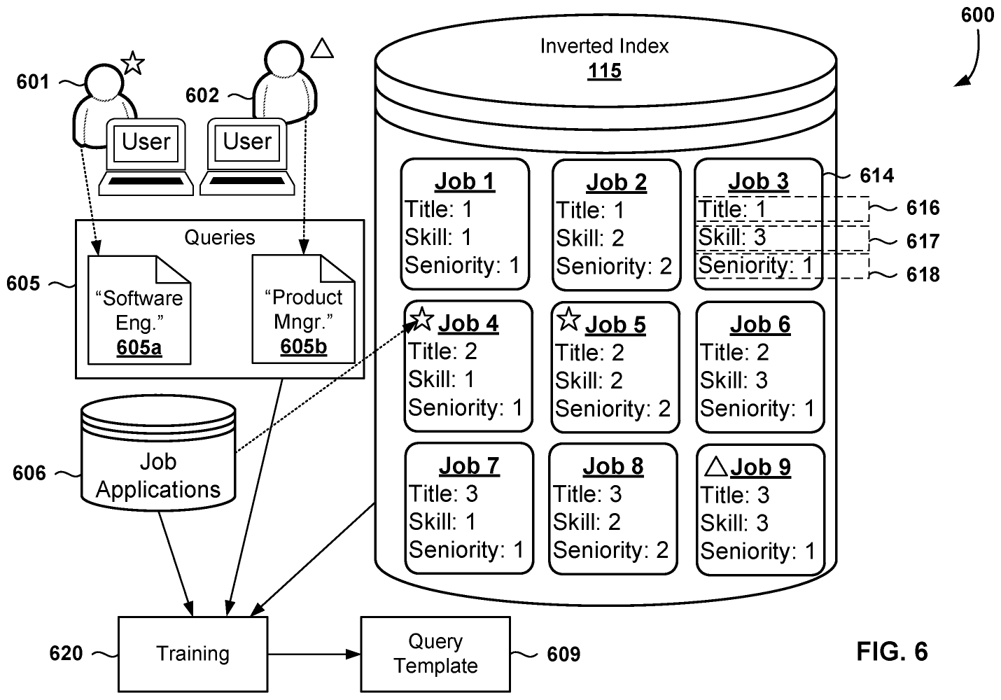

The search selection model 111 receives the incoming request 105 that may include raw search keywords, and the search selection model 111 may also use additional features not in the incoming request 105, such as location information of the user 101, to generate the search selection query 109 as an output. The search selection model 111 uses a query template and fills in the corresponding feature values (e.g., title=software developer) to obtain the search selection query 109. More details about the query template are provided below with reference to FIG. 6.

The search manager 130 is configurable to generate a predetermined number of documents 120 to control how many items may be selected for ranking 124 and presentation to the user. The output from the search of the inverted index 115 includes one or more documents 120, which are ranked by a ranking module 124 to generate the search results 125 that are presented, all or in part, to the user 101.

When the incoming request 105 is received, the search results 125 are determined in real time or near real-time among hundreds of millions of job postings. To speed up processing, robust standardization, intelligent query understanding and query suggestion, scalable indexing, high-recall document selection, effective ranking algorithms, and efficient multi-pass scoring/ranking systems are provided.

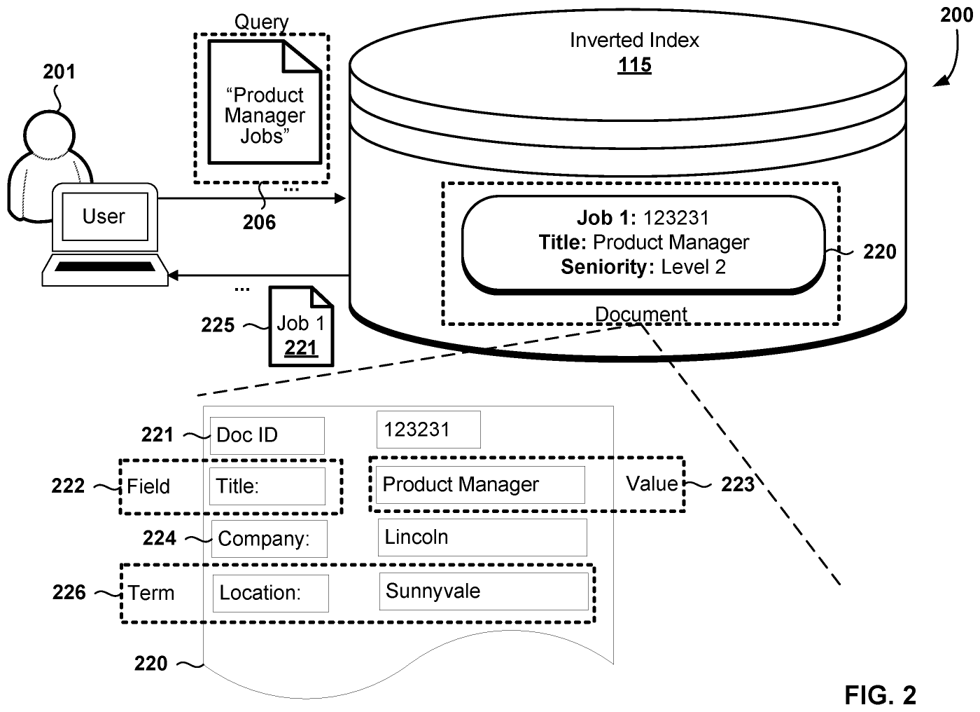

FIG. 2 is a high-level diagram of a system 200 for searching using an inverted index 115, according to some example embodiments. In the example embodiment of FIG. 2, a query 206 (e.g., “Product manager jobs”) is received from a client device of user 201. The search is performed in the inverted index 115 in order to find one or more documents related to the query 206, such as document 220.

The illustrated document 220 is a job posting, but other embodiments may search for other items, such as a user profile, an article, an ad, a possible connection, and the like. The document 220, which is depicted in a blown-out form in FIG. 2, is represented by a collection of terms 226. Each term 226 includes a field 222 and a value 223 for the field. Any term 226 of the document may be included in the inverted index 115, or a subset of the terms 226 may be included. For example, in FIG. 2, the term 226 includes a field 222 of “Title” and the corresponding value 223 of “Product Manager.” The values 223 associated with each field 222, may include the stored data related to the user's features that are associated with each of the generic field 222 names. The document 220 may include any number of terms to be searched, for example, the job posting may include job-related fields such as a document ID 221, a location, a title, a company name, and the corresponding values 223 to match each field 222.

In the example embodiment depicted in FIG. 2, the inverted index 115 has entries for the document 220 for a job posting for “Job 1.” The document 220 for Job 1 includes a term for document ID 221 and a corresponding value of 123231, a term for title and a corresponding value of “Product Manager,” a term for company 224 and a corresponding value of “Lincoln,” and a term for location and a corresponding value of “Sunnyvale.” The example query 206 is for searching “Product Manager Jobs,” and when the terms in the document are a positive match to the words in the query 206 (via the query template), then response 225 from the inverted index 115 will include the “Job 1” with document ID 221.

Further, some of the embodiments presented are described for the case when a search is initiated by a user, but the same principles may be used for cases when the system originates a search (e.g., to provide connection recommendations or job postings to a user). In this case, there is no search query, so the search may use the user features for creating the search selection query 109.

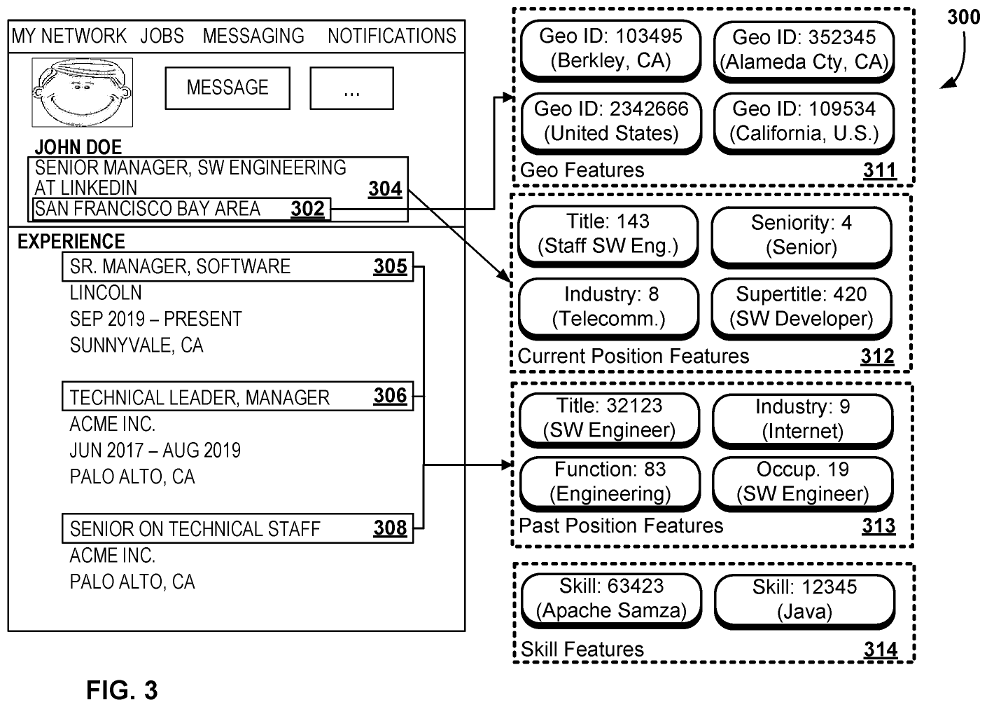

FIG. 3 is a screenshot 300 of a user profile, according to some example embodiments. In the illustrated example, the user profile includes several job positions 304, 305, 306, and 308 held by the user 101. In one example embodiment, each job position (304, 305, 306, 308) may include a company logo for the employer (not shown), a title (e.g., senior manager, software), the name of the employer (e.g., Lincoln), dates of employment, and a description of the tasks or responsibilities for the job. For job position 308, employment dates are unknown, so they are not shown.

In some example embodiments, the information on the user profiles may be categorized, that is, assigned to one from a finite number of available categories. For example, the company may include a company ID, a title may be assigned a title ID (where the title is standardized to cover a plurality of similar job titles), and a position may be assigned a position ID. In some example embodiments, each job position (user_position) may be described utilizing a record with one or more of the following fields:

```
user_position
  user_id: int,
  position_id: int,
  company_id: int,
  is_current: boolean, //TRUE if this is the current job
  industry _id: int,
  position_start_time: long,
  position_end_time: long
}
```

Other embodiments may include additional fields or fewer fields, or combine two or more fields.

In the illustrated example, user features (311, 312, 313, 314) may be used for the search and combined with the user-submitted search query. Document features may include any elements of the document that may be calculated or identified. The search may include the user features, the search query, and other externally sourced data related to the user.

For example, geography features 311 may include geo identifiers such as city names, county names, state names, and country names. The location 302 of a user's current position 304 may be used to source geography features 311. The user's current position 304 may provide relevant source data for current position features 312, such as title of the position, seniority level of the position, industry the position is based in, and the like. The user profile data may further be sourced to determine past positions 305, 306, and 308 to determine past position features 313. Finally, in the example embodiment of FIG. 3, skill features 314 may be sourced from the user profile.

In alternative example embodiments, tens and/or hundreds of different features may be determined based on user-related information, profile information, document information, search query information, and the like. Further, machine-learning algorithms may generate additional features such as title synonym features, title standardization features, skill standardization features, geo standardization features, and the like. In some example embodiments, categorical features are described as one-hot vectors. In other example embodiments, one or more of the features are represented with identifiers (e.g., an integer number or a real number). For example, each company in the connection network has its unique company identifier.

Each feature may be further subdivided into smaller categories. A title synonym feature may include alternative expression, substitutes, replacements, synonyms, or other words in place of the specified job position or title provided by the user. Title standardization features may include one or more elements or values related to title identifiers, functions, occupations, genericized occupation, specialty, seniority, and the like.

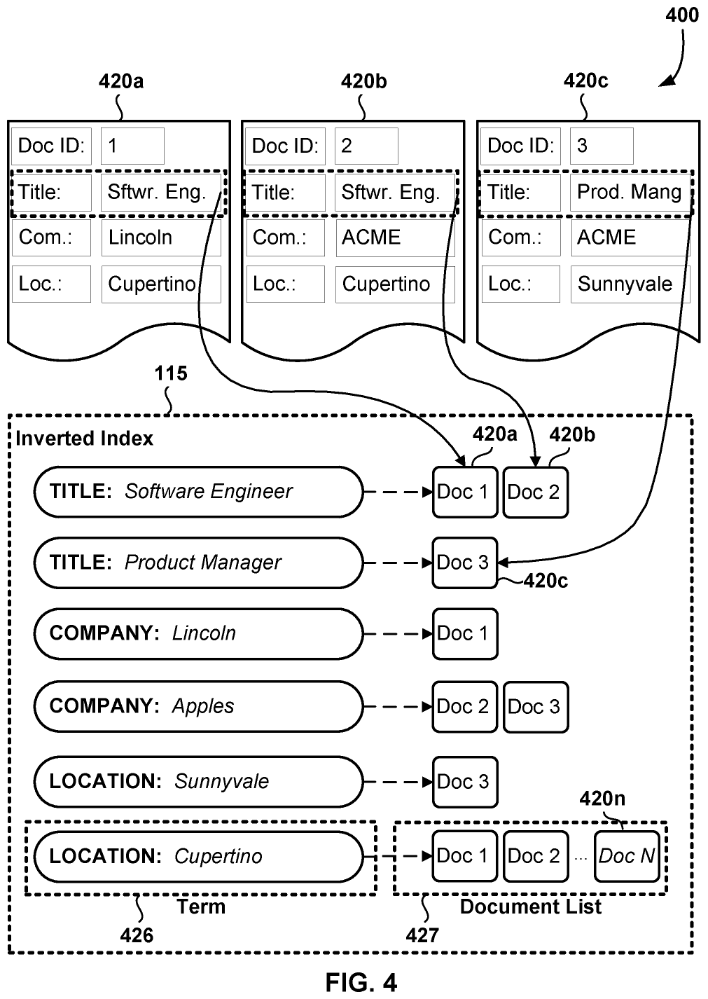

FIG. 4 is a block diagram 400 illustrating the generation of the inverted index 115, according to some example embodiments. The inverted index 115 is a data structure containing information on the documents stored in a database. Thus, in some example embodiments, the inverted index 115 may refer to documents based on company and title, but other embodiments may include additional features, such as an educational institution, a degree, a location, etc.

In the illustrated example, a user profile has information pertaining to three job postings that the user has held: a first job posting includes information in a first document 420a, where the user was a software engineer at a company name “Lincoln” located in Cupertino. The information of a user's second job is stored in a second document 420b, where the user was a software engineer for a company called “ACME” also located in Cupertino, and the user's third job includes information in a third document 420c, where the user was a product manager also for the company called “ACME” but located in Sunnyvale.

The inverted index 115 contains information associated with the documents 420a-420c. The inverted index 115 is optimized for retrieval of information based on one or more terms 426, where each term 426 is mapped to a document list 427. In some example embodiments, the document list 427 (e.g., Doc1, Doc2, . . . DocN) for the term 426 is a sorted list of document identifiers for the documents that include the term 426. The terms 426 in the inverted index may be of different kinds related to job postings, such as advertised job openings. The terms 426 in the inverted index are searched based on the search selection query submitted to the inverted index 115, and the document list 427 for the found terms are returned or combined based on the clauses found in the search selection query 109. In logic, a clause is a propositional formula formed from a finite collection of literals (atoms or their negations) and logical connectives. Searching the terms further includes iterating through the document list to collect document identifiers (420n) that will be returned as a result.

In some example embodiments index building involves significant computing power and time, such that an offline index is created to reduce latency. In alternative embodiments live, real time, or near-real time updates are created at an entity or user granularity level. Any updates to an entity require inserting a new version of the entire entity and deleting the old version. This becomes an immense overhead given that entities can contain hundreds of inverted index terms. Alternatively, in some example embodiments of the search index, term-partitioned segments are introduced in order to allow updating only the changed portions of the inverted index 115.

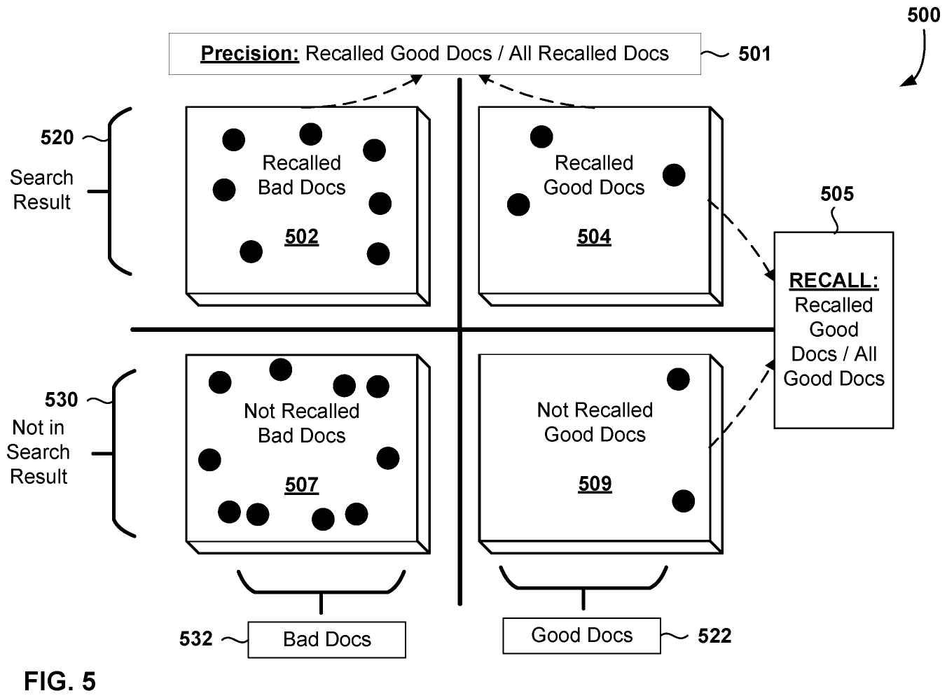

FIG. 5 is a chart 500 depicting the types of documents retrieved in a search and used for calculating precision 501 and recall 505, according to some example embodiments. There are a set of documents, and a search, based on a model, returns search results 520. The “good” documents 522 include all the correct documents for the given search (also referred to as “positives” because they are correct results for the search), and the “bad” documents 532 include all the incorrect documents for the search (also referred to as “negatives” because they are incorrect results for the search, that is, results that should not be returned for the search). Further, the returned search results 520 include documents that were correct results and labeled recalled good documents 504 (also referred to as “true positives” because the returned documents were actually good results for the search), and may also include incorrect documents labeled recalled bad documents 502 (also referred to as “false positives” because they were incorrectly included as results).

Further, there are the non-result documents 530 that were not included in the search results 520. The non-result documents 530 includes documents that should have been retrieved (labeled not-recalled good documents 509 also known as false negatives), and documents that were correctly excluded from the search results 520 (labeled not-recalled bad documents 507 also known as true negatives).

This division provides for the four categories of documents: (1) recalled “bad” documents 502, (2) recalled “good” documents 504, (3) not recalled “bad” documents 507, and (4) not recalled “good” documents 509. These four categories of documents are then used to calculate precision and recall percentages or values. That is, from the returned results, some results were correct while other results were incorrect, and from the unreturned results, some should have been returned as results and others were correctly excluded from the search results.

Precision 501 is a metric that measures the model's accuracy in classifying a sample as positive and is calculated as the number of search results properly labeled as good (true positives) divided by the number of all documents retrieved (that includes the true positives and the false positives). Recall 505 is a metric that measures the model's ability to detect good samples and is calculated as the number of properly obtained search results (recalled good documents 504) divided by the number of all the good documents (including true positives and false negatives).

In the illustrated example, where the dots represent the documents in each category, the precision 501 is equal to 3/10 or 0.3, and recall is equal to 3/5 or 0.6. The impact of recall may be difficult to measure in practice because it is unknown how a user would react to unretrieved documents. As such, recall can be improved by generating labels to classify the documents as either “good” or “bad” (where the delineation of “good” and “bad” can be calculated by a computational likelihood that a document includes a term associated with the user's query).

Precision and recall provide two ways to summarize the errors made for the positive class in a binary classification problem. Maximizing precision means minimizing the number of false-positive errors, whereas maximizing recall means minimizing the number of false-negative errors.

FIG. 6 is a diagram 600 for illustrating the training 620 process to create a query template 609, according to example embodiments. In this example embodiment, the inverted index 115 maintains information for job postings 614. The system further includes a list of queries 605 entered by users. In the illustrated example, user 601 and user 602 have entered queries 605a and 605b, respectively. User 601 has searched for job postings using keywords “software engineer” for the query 605a, and user 602 has searched using keywords “product manager” for query 605b.

Further, a job applications database 606 tracks the applications for job postings submitted by the users. In the illustrated example, user 601 has applied to job postings Job 4 and Job 5 (marked with a star), and user 602 has applied to job posting Job 9 (marked with a triangle).

The training 620 utilizes information on the users, the queries 605, the job applications, and the inverted index 115 to calculate a query template 609 that will be used for future searches. The query template 609 is a data structure that stores the format of a query that includes names of features to be searched and place holders for values associated with each of the features. When a search is performed for a given user, the values in the query template 609 are “filled in” based on the submitted query and information about the user associated with the search, as described above with reference to FIG. 1. The result of filling in the values of the features is the search selection query 109 to be used in the search.

The training 620 provides a unique advantage over other ML training methods because the training 620 calculates the precision and recall of queries so the resulting query template 609 will generate search selection models 111 that produce results with high precision and recall.

The inverted index 115 has three index fields: title 616, skill 617, and seniority 618. It is noted that any of the fields may be included in the search request, or the values of these fields may be selected from the searcher profile. In the illustrated example, each job posting 614 is presented with the values of the identifiers for the fields (e.g., Job 3 is for title ID 1, skill ID 3, and seniority ID 1).

In some example embodiments, a generic template for queries includes a series of subqueries connected with logical OR operations (disjunctions), where each subquery includes one or more feature checks. If multiple features are included in a subquery, the features in the subquery are connected by logical AND operators (conjunctions). An example query may have the following format:
C1 OR
(C2 AND C3) OR
(C3 AND C4) OR
(C5 AND C6) OR
(C6 AND C6 AND C8)

Each check Ci has the format (FEATUREᵢ=VALUEⱼ), where FEATUREᵢ is one of the features (e.g., title) and VALUEⱼ is a specific value for the feature (e.g., title ID=1) or a set of possible values (e.g., date of job posting>today minus 15 days). For illustration purposes, the examples will be described with reference to the use of specific values in each check, but other embodiments may use other types of checks.

Thus, the above example includes the subqueries C1, (C2 AND C3), (C3 AND C4), (C5 AND C6), and (C6 AND C6 AND C8). The number of subqueries may vary and is determined during the training 620.

When performing a search of the inverted index 115, searching for a query or subquery having a conjunction (e.g., performing a search with the “AND” operator) of search terms includes finding matches for all the terms. In one example embodiment, each document list 427 is sorted according to some criteria (e.g., smaller to highest, or vice versa). In one example embodiment, searching a subquery with one or more conjunctions, assuming that each document list is sorted from lowest value to highest value, may be performed as follows:
(1) identify the terms in the subquery;
(2) find the document list associated with each term;
(3) initialize a pointer for each document list (e.g., pointing to the first item in the document list);
(4) iteratively traverse the found document lists;
(4.1) if (the document IDs of the documents referenced by the pointer of each document list match) then
   add the document ID to the found set
   else move the pointer associated with the lowest document ID to point to the next document ID (assuming it exists; if it doesn't exist then exit iteration (4));
(4.2) repeat (4.1) until at least one document list has been completely traversed;
(5) return the found set.

For example, a query would search with a conjunction by joining the Title: {Software Engineer} AND Company: {Acme}. Using the conjunction in a search query tends to increase precision because of the increased number of constraints on the results, such that an optimal precision query may include {Feature1} AND {Feature2} . . . AND {FeatureN}. On the other hand, using conjunction reduces recall. Therefore, for higher precision and lower recall, a query should use AND statements. In one example, the optimal subquery can include the subquery that provides the highest value related to precision and a lowest value related to recall, as such, that optimal subquery is added to the query template by adding it with an AND connector.

Searching with a disjunction includes performing a search of an index using an “OR” between search terms. In one example embodiment, searching a subquery with one or more disjunctions, assuming that each document list is sorted from lowest value to highest value, may be performed as follows:
(1) identify the terms in the subquery;
(2) find the document list associated with each term; and
(3) create a union of the located document lists. For example, a query would search with a disjunction by adding the documents lists from Title: {Software Engineer} and Company: {Acme}.

Using the disjunction operator in a search query tends to increase recall and reduce precision, such that an optimal recall query may include {Feature1} OR {Feature2} . . . OR {FeatureN}. In other words, for lower precision and higher recall, a query should use OR statements. For example, the subquery that provides the optimal improvement to precision is added to the query template by adding it with an OR connector.

Further, searching with a conjunction and a disjunction, or one or more conjunctions with one or more disjunctions, may include performing a search of an index using both an OR operator and an AND operator between multiple search terms. For example, searching with both a conjunction and a disjunction may include the following operations:
(1) identify terms in a query;
(2) locate document lists associated with each term;
(3) iterate through all document lists;
(4) advance the pointer with the lowest document identifier; and
(5) subqueries act as an iterator with a logical binary value of 1 (e.g., TRUE).

For example, if the query includes multiple values for a Title term, e.g., a first title of “software engineer” and a second title of “product manager,” the two titles may be combined with a disjunction to get a subquery {Title: {Software Engineer} OR Title: {Product Manager}.

In order to calculate the optimal (e.g., highest precision and highest relevance) query structure that recalls the correct job postings while not recalling incorrect job postings, the training 620 determines which clause or clauses to include in the query template 609.

The optimal outcome would be a query that would return all the correct job postings and none of the incorrect job postings. However, there is usually a tradeoff to make sure only correct job postings are returned and omitting from the search results potentially correct job postings just to avoid having incorrect job postings returned. That is, there is a tradeoff between high precision and high recall, so the training aims at providing a good number of “good” job postings returned as results while avoiding the inclusion of incorrect (e.g., bad” job postings.

In order to find a search selection query focusing on both recall and precision, a query structure must be created by substituting an unknown variable in a query template 609 for a clause from a table.

A table is created based on multiple generated clauses, where each generated clause is based on one or more of the three inverted index fields (616, 617, 618). For example, the table is populated with six clauses: a clause representing each field in the index (e.g., a first clause for {title}, a second clause for {skill}, and a third clause for {seniority}. Additionally, the next three clauses are combinations of the different fields in the index joined together with a conjunction (e.g., a fourth clause may be {title AND skill}, a fifth clause may be {title AND seniority}, and a sixth clause may be {skill AND seniority}). One at a time, or one-by-one, a search is performed by iterating through each clause: in other words, for each of the six clauses, a search is performed, and matches are identified based on the specific iterative search for the specific clause.

In alternative example embodiments, clauses may be generated to include any number of inverted index fields that are available in the inverted index 115. For example, a clause may have three or more fields combined with a conjunction. In alternative example embodiments, permutations of field values may be added to the query to determine if a permutation of the one or more clauses may create a different combination of matches.

Once all the search clauses are searched, the clauses are ranked using a calculation to determine a ranking for each of the clauses. For example, a ranking function may be used to determine a ranking for each clause, where the ranking function calculates precision, which may be calculated by determining the number of applies for a job position divided by total matches. Another ranking function might use F beta score, which combines precision and recall measurements into 1 score for each clause. Once a highest-ranking (e.g., optimal) clause is determined accordingly, the search selection query is updated, and a second iteration of the search selection model is run. In the second iteration, the search selection query is changed to input the highest-ranking clause, and the remaining five clauses (delineated above) are re-run to determine a second clause to substitute in for the unknown value (e.g., variable) in the query template 609. The second clause is added to the search selection query using a disjunction “OR” statement in order to increase the recall of the number of job postings found in the search index. The table is again updated based on the remaining number of clauses.

A new search must be run iteratively, e.g., every time the query iteration is run, because every time a clause is added to the query to calculate the next clause to add to the query, the incremental benefits associated with each clause in the existing query changes. In the example embodiment disclosed in FIG. 6, only two users are illustrated with three inverted search fields in order to demonstrate a process; however, such a process is run through a search selection algorithm employing artificial intelligence and machine learning to formulate the search selection model. Using ML, the search selection model may be calculated based on 100s of clauses to choose from, 100,000 job descriptions to choose from, 30,000 queries (instead of the two users of FIG. 6), and 10,000 applies to the job applications database 606 to choose from, such math is impossible to replicate by a human mind or mathematical equation on paper.

A sample environment is used for describing how to generate the query template 609. In this example, queries 605a and 605b are submitted by user 601 and user 602 respectively, and the features of the inverted index 115 include Title, Skill, and Seniority. Further, previous job applies for Job 4 (user 601), Job 5 (user 601), and Job 9 (user 602) are considered for labeling. An analysis of the users shows that user 601 matches parameters {Title 1, Title 2, Skill 1, Seniority 2}, while user 602 matches parameters {Title 3, Skill 2, Seniority 1}.

Thus, there could be matches between the users and the title, skill, or seniority of the job postings 614, or any combination thereof. For example, a search of (title AND seniority) would match Jobs 2 and 5 for user 601 and Jobs 7 and 9 for user 602.

Further, a search of (title AND seniority AND skill) would not find any matches, that is, the search is too precise. The opposite problem of not being precise enough appears if all the features are combined with OR (title OR seniority OR skill) because it would return jobs 1-8 for user 601 and all the jobs for user 602.

In some example embodiments, labels can be assigned based on the context of each user; for example, a job posting may be labeled “good” for user 601, but the same job posting may be labeled “bad” for user 602. Additionally, documents can be labeled in different ways. For example, a first method of labeling a document may be based on a user's past actions, so job postings that the user applied to (also referred to simply as applies) are labeled as “good” and the other job postings are labeled as “bad.” One goal is to return results that include the “good” job postings but not the “bad” job postings.

Alternative or additional methods of labeling a document may include ranking scores of a document. For example, if a document would show up on the first page of a user's result, this would result in a “good” label, whereas if the document would not show up on the first page of a user's result, this would result in a “bad” label. An additional example of labeling for job applications may include an index that contains job postings created before a certain date (e.g., June 1). The index is labeled on June 15 with real user job application data occurring from June 1 through June 15. As such, job postings (e.g., documents) in the index that have an apply by the user between June 1 and June 15 are marked with a “good” label. In alternative example embodiments, labeling may change on a per-user basis, or be marked based on any constraints, terms, values, or results determined by a developer or a user.

Next the goal is to identify which clauses (e.g., subqueries) to include in the query template 609 to get the optimal precision and recall based on the labels determined by the job applications. First, a Table 1 is built with all the possible subqueries, as follows:

TABLE 1

| | | | |
|---|---|---|---|
| Clause (subquery) | Applies | Other matches | Precision |

title AND skill AND seniority
title AND skill
title AND seniority
skill AND seniority
title
skill
seniority

The subquery (title AND skill AND seniority) is eliminated in this case because it does not return any results. The goal is to determine which clauses to include in the query template 609 to get the optimal precision and recall.

A search is performed for each clause by comparing, for each user, the values of the user features to the values of the job postings (e.g., title-1 for user 602) and the results are analyzed to determine the number of returned applies (e.g., good search results) and the number of other returned jobs (bad search results).

Afterwards, the precision is calculated as the number of applies divided by the total number of matches. The results of analyzing each subquery are presented in Table 2:

TABLE 2

| Clause (subquery) | Applies | Other matches | Precision |
|---|---|---|---|
| title AND skill AND seniority | 0 | 0 | 0 |
| title AND skill | 1 | 2 | 33% |
| title AND seniority | 2 | 2 | 50% |
| skill AND seniority | 0 | 0 | 0 |
| title | 3 | 6 | 33% |
| skill | 1 | 5 | 17% |
| seniority | 2 | 7 | 29% |

Thus, the clause of (title AND seniority) has the highest precision. This clause is added to the query template 609 and retired from further configuration. The next iteration is to add another clause to the query template 609, that is (title AND seniority) OR X).

For each remaining candidate query, the applies and other matches are calculated as ((title AND seniority) OR Clause). Then, the precision is calculated, resulting in Table 3 below:

TABLE 3
(title AND seniority) OR Clause

| Clause (subquery) | Applies | Other matches | Precision |
|---|---|---|---|
| title AND skill | 3 | 4 | 43% |
| skill AND seniority | 2 | 2 | |
| title | 3 | 6 | 33% |
| skill | 3 | 7 | 30% |
| seniority | 2 | 7 | |

It is noted that the clauses (skill AND seniority) and (seniority) are not considered, so the precision is not calculated, because they generate the same number of applies as (title AND seniority) alone, so they do not add to the precision already in the query template 609.

Of the remaining clauses, (title AND skill) has the highest precision, so it is added to the query template 609. Then, the query template 609 would produce results and include all the applies of user 601 and user 602. That is, the process continues until all the “good” labels are returned, or until all the clauses are exhausted.

This means that the optimal query template 609 has been found, so the process stops with the query template 609 as ((title AND seniority) OR (title AND skill)). This query template 609 has a recall of 100% and a precision of 43%, as seen in Table 3.

Thus, if a search is performed for a particular user, the filled in query template 609 is the search selection query 109, such as the following:
(title=Title957 AND seniority=Seniority456) OR
(title=Title957 AND skill=Skill41)

The described example refers to features for the users, but other embodiments may include features associated with the search (e.g., “Data Scientist”) combined with user features.

If a value for a feature is not available, the corresponding check for that feature will be FALSE, such as if a user has no skill in the user profile, then the check for skill will be FALSE.

In a real system, the number of job postings may be 100,000, the number of user queries analyzed may be 30,000, and the number of job applies may be 10,000. The result of the training 620 may be the query template 609 with hundreds of clauses, and this query template 609 will provide high recall and precision for the searches of the users.

In some example embodiments, a separate index may be used to maintain a list of the “unretrieved documents” in order to compare the unretrieved documents to other unretrieved documents from one or more second queries to calculate an overlap in unretrieved documents. An iterative cycle of unretrieved document comparison may be calculated to determine an increase and/or decrease of relevance of a document for a user.

In alternative example embodiments, the search selection model provides the ability to assign a static rank to each document in the document list associated with a term. This is a measure of the importance of that document (e.g., job listing) independent of any search query and is determined offline during the index building process. Using the static rank, the documents are ordered in the document lists of the index by importance, placing the most important documents for a term first in the document list. The retrieval process can then be terminated (referred to as early termination) as soon as a predetermined number of documents are obtained that match the query, not having to retrieve every document that matches the query.

In additional example embodiments, flex queries can be implemented, which include a constraint on the minimum and maximum number of documents retrieved by a particular clause of a query. Thus, when the maximum number of documents are retrieved for the clause, the flex query is “disabled” and discarded from further consideration. A query does not terminate early until the minimum number of documents are retrieved by the flex query.

For example, supposing there are 10 “good documents” in the index and the precision of the “ALL” query is measured, which retrieves all 10,000 documents from the hypothetical index. Without early termination the precision would be 10/10,000. With early termination set to 2,000 documents, the precision might be as high as 10/2,000 or as low as 0/2,000, it may depend, for example, on the static rank of the “good documents.”

Early termination works if the static rank of an entity is somewhat correlated to its final score for any query. One example benefit of early termination is improved performance. For example, scoring documents for ranking is usually an expensive operation and the fewer the documents scored the better. In other words, early termination allows more sophisticated scorers/ranking to be used. To maximize the benefit of early termination, the query rewriting process should bias the query towards retrieving the most relevant documents. It is difficult to measure precision without a search index because of hard-to-simulate search functionality, such as early termination that applies a constraint on the maximum number of documents retrieved per query. Documents with the highest static rank are retrieved first.

If a query does encounter an early termination, it means there might be “good documents” that a query would normally find, but early termination stops the query execution before those “good documents” are retrieved. By making the query more precise, recall can be increased by retrieving more “good documents” before early termination happens.

Additional example embodiments may further include antonyms, opposites, contra-indications, or the like as alternative negative features to be provided as input for the model.

In example embodiments, when calculating or determining precision importance and recall importance, not all features are identified as being equally as important to any other given feature. For example, the training infrastructure configured to train the search selection model to optimize for precision and recall may calculate different features to determine an optimal precision value versus features to determine an optimal recall value. For exemplary purposes, an optimal precision value and/or an optimal recall value may change based on any given set of features or desired outcomes of a machine learning model. For example, an optimal precision value and/or an optimal recall value may be calculated based on optimal parameters or features on a per-user, per-document, per-search, or per-query basis. In alternative example embodiments, different dimensions in the data may be measured to determine what is considered an optimal precision value and/or an optimal recall value for any given query, including, for example, computing averages, computing highs and lows, computing a best action through trial and error, and the like.

In one example embodiment, precision may be determined to be of higher value than recall, where in other embodiments recall may be determined to be of higher value than precision. Precision is important because not all features are as important compared to other features when calculating precision. For example, a geo feature 311 of “United States” may be too general, because a job candidate will not move from New York to Washington. A current position feature 312 of “Staff Software Engineer” may still be too general, as a position could be located in any city of any country. However, a skill feature 314 of “Apache Samza” may be too specific because the user may be willing to work with other skills. If the recall is maintained at a constant but the query is made more specific, then the system may retrieve the same good hits (e.g., searches in the index) with fewer documents returned, which results in a faster search execution time, which in turn, causes lower latency and cost to use.

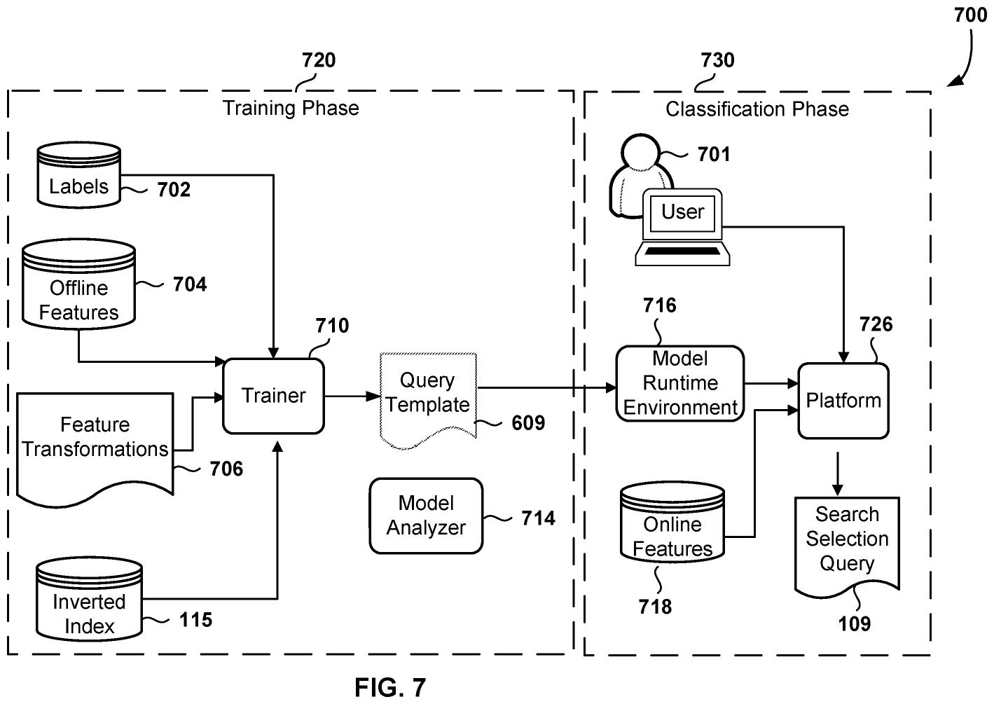

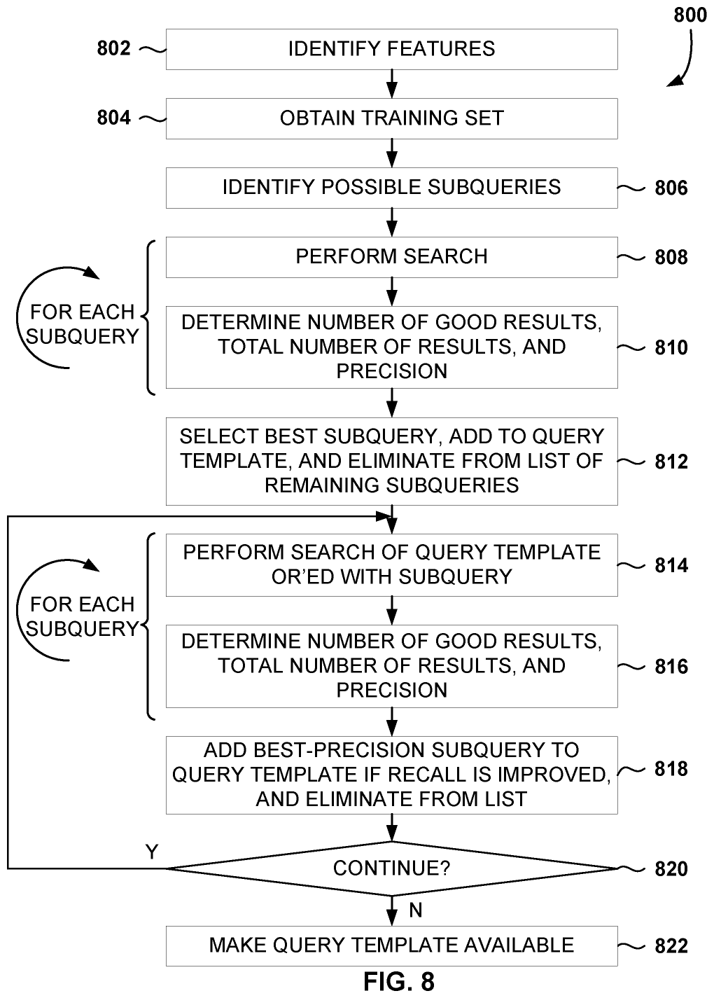

FIG. 7 is a block diagram 700 depicting a training phase 720 and a classification phase 730 to utilize the query template for user searches, according to some example embodiments. A training phase 720 occurs employing machine-learning (ML) techniques in a communications network training infrastructure, such as a trainer 710 that creates the query template 609. More details about the training process are described below with reference to FIG. 8.

The trainer 710 imports different parameters and features from external databases operably interconnected to the trainer. For example, the trainer 710 imports document labels from a label database 702 (e.g., applies), features from an offline features database 704 (e.g., user profiles, job postings, articles), one or more files defining feature transformations 706 from a machine-learning (ML) platform 726, and the inverted index 115.

The trainer 710 calculates the query template 609 based on one or more features. Further, the trainer 710 can use a model analyzer component 714 to calculate the precision and the recall for a given set of results.

The model analyzer uses, for example, the input request data, the input metadata, details on how the query matched the terms in a search index, and the forward index to determine the importance of a document as a result for the search. Simple scorers can be hand-tuned, but more sophisticated scorers are built semi-automatically using a machine learning pipeline. The query template 609 is published so the query template 609 can be used during a classification phase 730 to generate the search selection query 109 for searching

The model runtime environment 716 can be a sub-system that exists both in the computer where a program is created, as well as in the computers where the program is intended to be run.

In the classification phase 730, the search selection query 109 is used to perform searches for the user 701 based on online features 718. Typically, algorithms such as ML models are used to rank the items in order of relevance by assigning a relevance score to each item and then sorting the items according to their relevance. By providing the highest-relevant items, the probability that the user will interact with presented items is higher than if the items were not presented according to their relevance. Relevance denotes how well a retrieved document or set of documents meets the information needs of the user. Relevance may include concerns such as timeliness, authority, or novelty of the result. The relevance may be based on past user behaviors, also referred to as user engagements, e.g., the interactions of users with items presented to the users. There is a training process that uses the training data based on the past interactions to build the ranking models.

FIG. 8 illustrates a flowchart of a method 800 for creating the query template, according to some example embodiments. While the various operations in this flowchart are presented and described sequentially, one of ordinary skill will appreciate that some or all of the operations may be executed in a different order, be combined or omitted, or be executed in parallel.

Operation 802 is for identifying the features that will be used create the query template, where the features can be job-posting features and user features.

From operation 802, the method 800 flows to operation 804 to obtain a training set. For example, the training set may include data from user profiles, user-submitted queries, job postings, and job applications submitted by users, but other embodiments may use additional or fewer features.

From operation 804, the method 800 flows to operation 806 to identify the possible subqueries, such as by identifying subqueries with a single feature and subqueries resulted by combining two or more features connected by the logical operator AND. In some example embodiments, all combinations may be considered, or only subqueries with a predetermined number of features (e.g., maximum of 5), or limit the combinations based on other criteria, such as relative importance of each feature.

After operation 806, operations 808 and 810 are performed for each of the subqueries. At operation 808, a search is performed using the corresponding subquery. At operation 810, based on the results of the search, a determination is made of the number of “good” results and the total number of results, followed by the calculation of the precision, as described above with reference to Tables 1-3.

At operation 812, the subquery is the one that provides the higher (e.g., optimal) precision, which is then selected and added to the query template. Further, the added subquery is eliminated from further consideration.

From operation 812, the method 800 flows the operation 814 to continue with iterations to add, if necessary, additional subqueries to the query template. For each of the remaining subqueries, operations 814 and 816 are performed. At operation 814, a search is performed using the current query template combined with a logical OR of the corresponding subquery. Operation 816 is the same as operation 810 for the results obtained in operation 814.

At operation 818, if any subquery exists that improves precision and recall, then from all the subqueries that improve recall, the subquery that provides the highest improvement to precision is added to the query template by adding it with an OR connector.

At operation 820, a check is made to determine if more iterations are needed. The check may include not exceeding a predetermined number of maximum iterations, or a check to determine if recall is higher than a predetermined threshold. If new iterations are required, the method flows back to operation 814, and if new iterations are not required, the method flows to operation 822.

At operation 822, the query template is stored in memory or disk and made available for future searches.

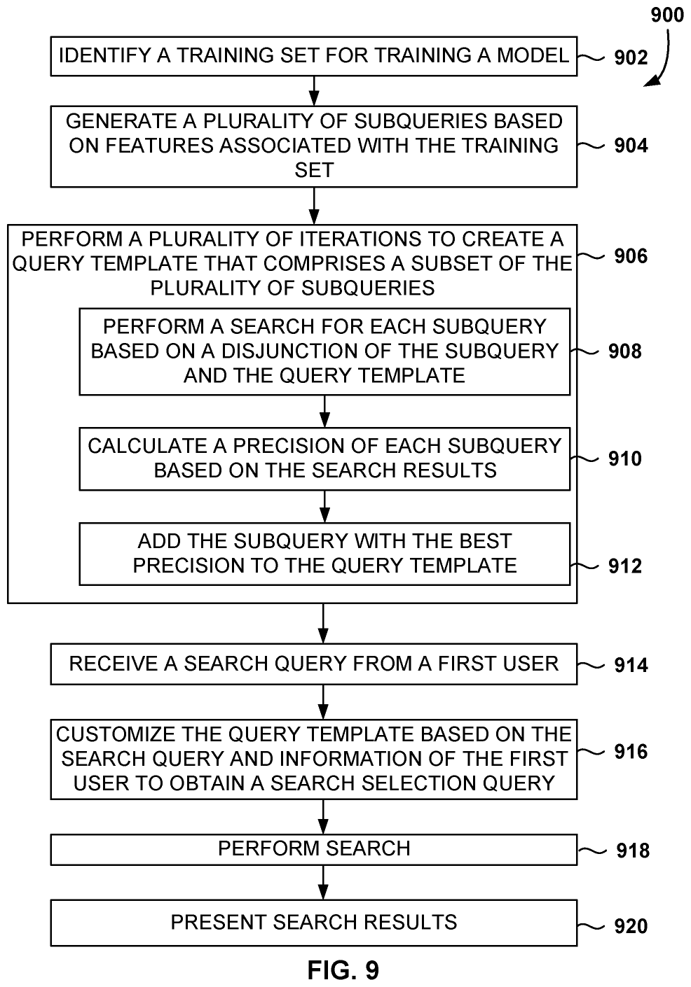

FIG. 9 is a flowchart of a method 900 for creating a query template optimized for recall and precision to be used in database searches. While the various operations in this flowchart are presented and described sequentially, one of ordinary skill will appreciate that some or all of the operations may be executed in a different order, be combined or omitted, or be executed in parallel.

Operation 902 is for identifying a training set for training a model. The training set comprises information on user profiles, job postings, user-entered queries, and job applications submitted on an online service.

From operation 902, the method 900 flows to operation 904 to generate a plurality of subqueries based on features associated with the training set.

From operation 904, the method 900 flows to operation 906 to perform performing a plurality of iterations to create the query template that comprises a subset of the plurality of subqueries. Each iteration comprises operations 908, 910, and 912.

At operation 908, a search is performed for each subquery based on a disjunction of the subquery and the query template.

From operation 908, the method 900 flows to operation 910 to calculate a precision of each subquery based corresponding search results.

From operation 910, the method 900 flows to operation 912 where the subquery that provides the highest improvement to precision is added to the query template.

After the iterations are complete, at operation 914 receiving a search query is received from a device of a first user.

From operation 914, the method 900 flows to operation 916 to customize the query template based on the search query and information of the first user to obtain a search selection query.

From operation 916, the method 900 flows to operation 918 to perform a search utilizing the search selection query.

From operation 918, the method 900 flows to operation 920 to cause presentation of search results on a display.

In one example, each subquery from the plurality of subqueries comprises a single check or several checks joined by a Boolean AND operation, each check being a condition for a feature being equal to a given value.

In one example, the query template comprises the subset of the plurality of subqueries joined by a Boolean OR operation.

In one example, performing the search for each subquery comprises traversing an index of job postings stored in a database of job postings, the index comprising a sorted document list for each value associated with one feature, the traversing comprising: when traversing several checks of features joined by conjunction, traversing together the sorted document lists of the features to find job postings.

In one example, the traversing further comprises, when traversing several checks of features joined by disjunction, adding the sorted document lists for the values of the joined features.

In one example, the precision is calculated as number of job postings with job applies in the search results divided by the number of search results.

In one example, performing the plurality of iterations further comprises after adding the subquery with the highest improvement to precision, eliminating the added subquery from consideration in future iterations.

In one example, the features in the plurality of subqueries comprise title identifier, skill identifier, seniority identifier, and geographic location identifier.

In one example, performing the plurality of iterations further comprises stopping the iterations after a recall of job applications is complete.

In one example, performing the plurality of iterations further comprises stopping the iterations after a predetermined number of maximum iterations are performed.

Another general aspect is for a system that includes a memory comprising instructions and one or more computer processors. The instructions, when executed by the one or more computer processors, cause the one or more computer processors to perform operations comprising: identifying a training set for training a model, the training set comprising information on user profiles, job postings, user-entered queries, and job applications submitted on an online service; generating a plurality of subqueries based on features associated with the training set; performing a plurality of iterations to create a query template that comprises a subset of the plurality of subqueries, each iteration comprising: performing a search for each subquery based on a disjunction of the subquery and the query template; calculating precision of each subquery based corresponding search results; and adding the subquery with the optimal precision to the query template; receiving a search query from a first user; customizing the query template based on the search query and information of the first user to obtain a search selection query; performing a search utilizing the search selection query; and causing presentation of search results on a display.

In yet another general aspect, a tangible machine-readable storage medium (e.g., a non-transitory storage medium) includes instructions that, when executed by a machine, cause the machine to perform operations comprising: identifying a training set for training a model, the training set comprising information on user profiles, job postings, user-entered queries, and job applications submitted on an online service; generating a plurality of subqueries based on features associated with the training set; performing a plurality of iterations to create a query template that comprises a subset of the plurality of subqueries, each iteration comprising: performing a search for each subquery based on a disjunction of the subquery and the query template; calculating precision of each subquery based corresponding search results; and adding the subquery with the optimal precision to the query template; receiving a search query from a first user; customizing the query template based on the search query and information of the first user to obtain a search selection query; performing a search utilizing the search selection query; and causing presentation of search results on a display.

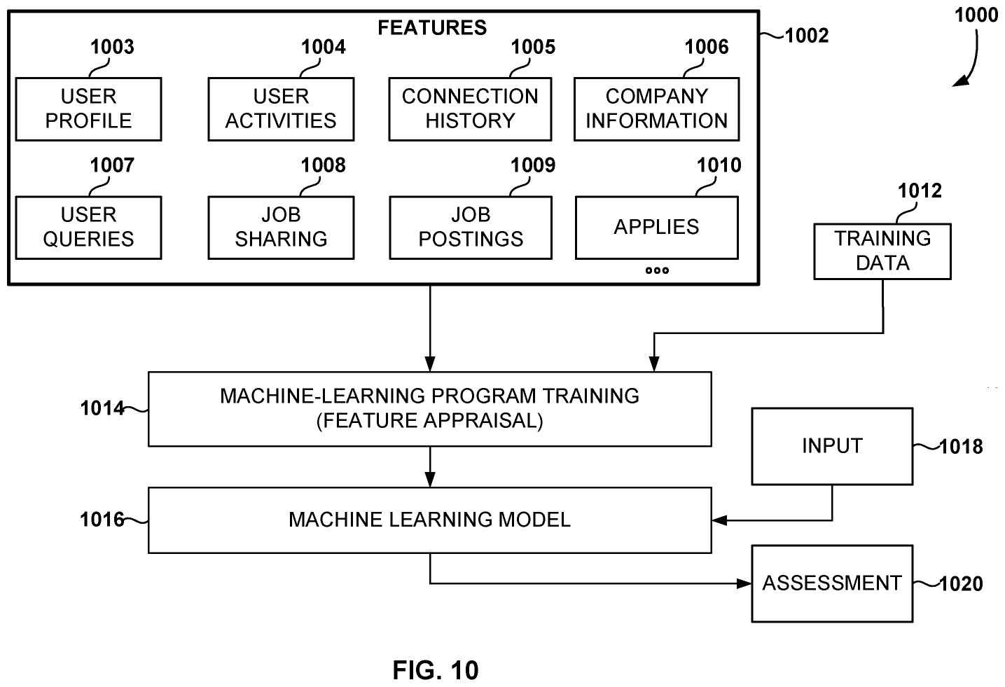

FIG. 10 illustrates a system 1000 for the training and use of a machine-learning model, according to some example embodiments. In some example embodiments, machine-learning (ML) models 1016, are utilized to calculate the models for calculating job-posting relevance, PYMK, feed-item relevance, news relevance, etc.

In some example embodiments, machine-learning programs (MLP), also referred to as machine-learning algorithms or tools, are utilized to perform operations associated with career transitions, such as finding people with similar profiles that recently had a career transition, showing career transitions for similar people, etc.

Machine Learning (ML) is an application that provides computer systems the ability to perform tasks, without explicitly being programmed, by making inferences based on patterns found in the analysis of data. Machine learning explores the study and construction of algorithms, also referred to herein as tools, which may learn from existing data and make predictions about new data. Such machine-learning algorithms operate by building an ML model 1016 from example training data 1012 in order to make data-driven predictions or decisions expressed as outputs or assessments 1020. Although example embodiments are presented with respect to a few machine-learning tools, the principles presented herein may be applied to other machine-learning tools.

There are two common modes for ML: supervised ML and unsupervised ML. Supervised ML uses prior knowledge (e.g., examples that correlate inputs to outputs or outcomes) to learn the relationships between the inputs and the outputs. The goal of supervised ML is to learn a function that, given some training data, best approximates the relationship between the training inputs and outputs so that the ML model can implement the same relationships when given inputs to generate the corresponding outputs. Unsupervised ML is the training of an ML algorithm using information that is neither classified nor labeled, allowing the algorithm to act on that information without guidance. Unsupervised ML is useful in exploratory analysis because it can automatically identify structure in data.

Common tasks for supervised ML are classification problems and regression problems. Classification problems, also referred to as categorization problems, aim at classifying items into one of several category values (for example, is this object an apple or an orange?). Regression algorithms aim at quantifying some items (for example, by providing a score to the value of some input). Some examples of commonly used supervised-ML algorithms are Logistic Regression (LR), Naive-Bayes, Random Forest (RF), neural networks (NN), deep neural networks (DNN), matrix factorization, and Support Vector Machines (SVM).

Some common tasks for unsupervised ML include clustering, representation learning, and density estimation. Some examples of commonly used unsupervised-ML algorithms are K-means clustering, principal component analysis, and autoencoders.

The training data 1012 comprises examples of values for the features 1002. In some example embodiments, the training data comprises labeled data with examples of values for the features 1002 and labels indicating the outcome, such a user applied for a job-posting that was presented, a user accepted an invitation to connect, a connection was made, etc. The machine-learning algorithms utilize the training data 1012 to find correlations among identified features 1002 that affect the outcome. A feature 1002 is an individual measurable property of a phenomenon being observed. The concept of a feature is related to that of an explanatory variable used in statistical techniques such as linear regression. Choosing informative, discriminating, and independent features is important for effective operation of ML in pattern recognition, classification, and regression. Features may be of different types, such as, numeric, strings, categorical, and graph. A categorical feature is a feature that may be assigned a value from a plurality of predetermined possible values (e.g., this animal is a dog, a cat, or a bird).

In one example embodiment, the features 1002 may be of different types and may include one or more of user profile information 1003, user activity information 1004 (e.g., articles read, jobs applied to, connections made, articles posted, jobs posted), connection history 1005, company information 1006, user-submitted queries 1007, jobs shared or posted 1008, job postings 1009, applies 1010, etc.

During training 1014, the ML program, also referred to as ML algorithm or ML tool, analyzes the training data 1012 based on identified features 1002 and configuration parameters defined for the training. The result of the training 1014 is the ML model 1016 that is capable of taking inputs 1018 to produce assessments 1020.

Training an ML algorithm involves analyzing large amounts of data (e.g., from several gigabytes to a terabyte or more) in order to find data correlations. The ML algorithms utilize the training data 1012 to find correlations among the identified features 1002 that affect the outcome or assessment 1020. In some example embodiments, the training data 1012 includes labeled data, which is known data for one or more identified features 1002 and one or more outcomes.

The ML algorithms usually explore many possible functions and parameters before finding what the ML algorithms identify to be the best correlations within the data; therefore, training may make use of large amounts of computing resources and time. When the ML model 1016 is used to perform an assessment, the input 1018 is provided to the ML model 1016, and the ML model 1016 generates the assessment 1020 as output. For example, the ad relevance is calculated as the assessment 1020 when the user ID and the ad ID are used as inputs. In another example, the relevance of a search suggestion is calculated as the assessment 1020 when the user IDs of the viewing user and the search user in the connection are provided.

In some example embodiments, results obtained by the model 1016 during operation (e.g., assessments 1020 produced by the model in response to inputs) are used to improve the training data 1012, which is then used to generate a newer version of the model. Thus, a feedback loop is formed to use the results obtained by the model to improve the model.

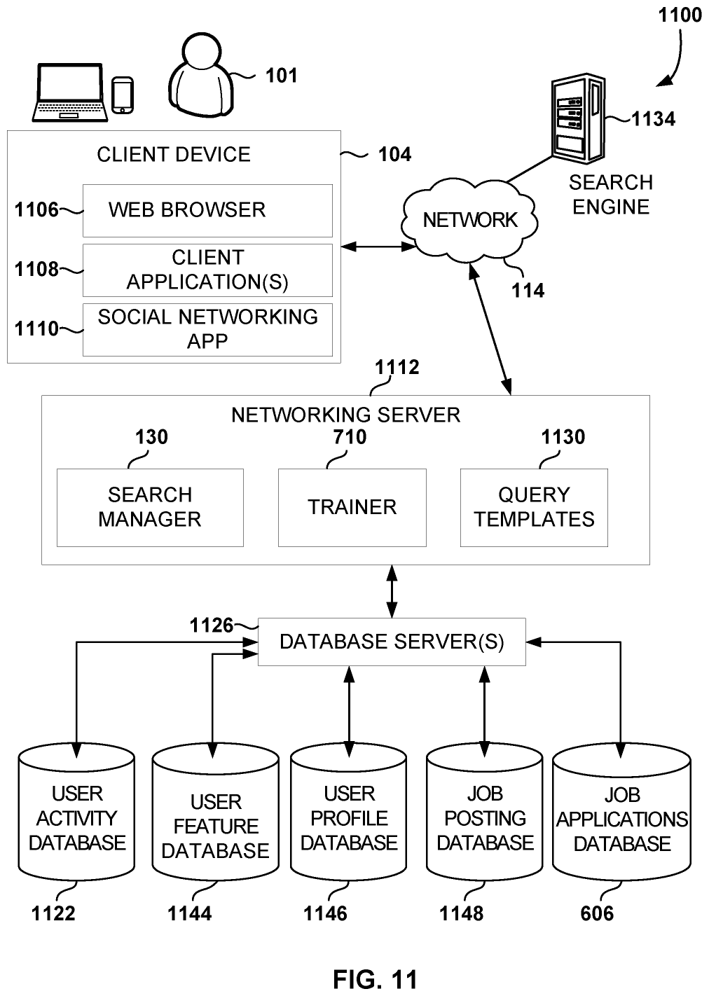

FIG. 11 is a block diagram illustrating a networked architecture 1100, according to some example embodiments, including a networking server 1112, illustrating an example embodiment of a high-level client-server-based network architecture 1100. Embodiments are presented with reference to an online service, and, in some example embodiments, the online service is a social networking service.

A networking server 1112 may include a distributed system comprising one or more machines, provides server-side functionality via a network 114 (e.g., the Internet or a wide area network (WAN)) to one or more client devices 104.

FIG. 11 illustrates, for example, a client device 104 with a web browser 1106, client application(s) 1108, and a social networking app 1110 executing on the client device 104. The networking server 1112 is further communicatively coupled with one or more database servers 1126 that provide access to one or more databases 1142, 1144, 1146, 1148, and 606.

The networking server 1112 includes, among other modules, a search manager 130, a trainer 710, and query templates 1130. The search manager 130 is a module for performing searches (e.g., in job posting database 1148). The query templates includes one or more query templates for use while searching the different databases. The client device 104 may comprise, but is not limited to, a mobile phone, a desktop computer, a laptop, a tablet, a netbook, a multi-processor system, a microprocessor-based or programmable consumer electronic system, or any other communication device that the user 101 may utilize to access the networking server. In some embodiments, the client device 104 may comprise a display module (not shown) to display information (e.g., in the form of user interfaces).

In one embodiment, the networking server 1112 is a network-based appliance, or a distributed system with multiple machines, which responds to initialization requests or search queries from the client device 104. One or more users 101 may be a person, a machine, or other means of interacting with the client device 104. In various embodiments, the user 101 interacts with the networking server 1112 via the client device 104 or another means.

In some embodiments, if the social networking app 1110 is present in the client device 104, then the social networking app 1110 is configured to locally provide the user interface for the application and to communicate with the networking server, on an as-needed basis, for data and/or processing capabilities not locally available (e.g., to access a user profile, to authenticate a user 101, to identify or locate other connected users 101, etc.). Conversely, if the social networking app 1110 is not included in the client device 104, the client device 104 may use the web browser 1106 to access the networking server.

In addition to the client device 104, the networking server communicates with the one or more database servers 1126 and databases. In one example embodiment, the networking server is communicatively coupled to the user activity database 1142, a user feature database 1144, a user profile database 1146, a job posting database 1148, and a job applications database 606. The databases may be implemented as one or more types of databases including, but not limited to, a hierarchical database, a relational database, a graph database, an object-oriented database, one or more flat files, or combinations thereof.

In some example embodiments, when a user 101 initially registers to become a user 101 of the social networking service provided by the networking server, the user 101 is prompted to provide some personal information, such as name, age (e.g., birth date), gender, interests, contact information, home town, address, spouse's and/or family users' names, educational background (e.g., schools, majors, matriculation and/or graduation dates, etc.), employment history (e.g., companies worked at, periods of employment for the respective jobs, job title), professional industry (also referred to herein simply as “industry”), skills, professional organizations, and so on. This information is stored, for example, in the user profile database 1146. Similarly, when a representative of an organization initially registers the organization with the social networking service provided by a network, the representative may be prompted to provide certain information about the organization, such as a company industry.

While the database server(s) 1126 are illustrated as a single block, one of ordinary skill in the art will recognize that the database server(s) 1126 may include one or more such servers. Accordingly, and in one embodiment, the database server(s) 1126 implemented by the social networking service are further configured to communicate with a networking server.

The network architecture 1100 may also include a search engine. Although only one search engine 1134 is depicted, the network architecture 1100 may include multiple search engines 1134. Thus, the networking server may retrieve search results (and, potentially, other data) from multiple search engines 1134. The search engine 1134 may be a third-party search engine.

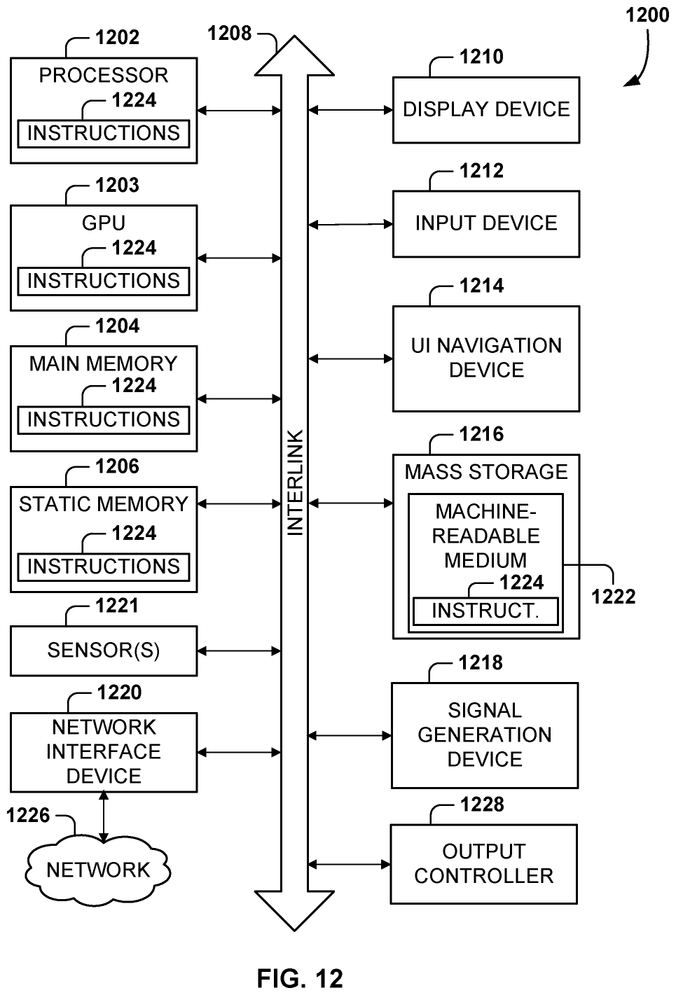

FIG. 12 is a block diagram illustrating an example of a machine 1200 upon or by which one or more example process embodiments described herein may be implemented or controlled. In alternative embodiments, the machine 1200 may operate as a standalone device or may be connected (e.g., networked) to other machines. In a networked deployment, the machine 1200 may operate in the capacity of a server machine, a client machine, or both in server-client network environments. In an example, the machine 1200 may act as a peer machine in a peer-to-peer (P2P) (or other distributed) network environment. Further, while only a single machine 1200 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, a number of components, or mechanisms. Circuitry is a collection of circuits implemented in tangible entities that include hardware (e.g., simple circuits, gates, logic). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits) including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 1200 may include a hardware processor 1202 (e.g., a central processing unit (CPU), a hardware processor core, or any combination thereof), a graphics processing unit (GPU) 1203, a main memory 1204, and a static memory 1206, some or all of which may communicate with each other via an interlink (e.g., bus 1208). The machine 1200 may further include a display device 1210, an alphanumeric input device 1212 (e.g., a keyboard), and a user interface (UI) navigation device 1214 (e.g., a mouse). In an example, the display device 1210, alphanumeric input device 1212, and UI navigation device 1214 may be a touch screen display. The machine 1200 may additionally include a mass storage device (e.g., drive unit) 1216, a signal generation device 1218 (e.g., a speaker), a network interface device 1220, and one or more sensors 1221, such as a Global Positioning System (GPS) sensor, compass, accelerometer, or another sensor. The machine 1200 may include an output controller 1228, such as a serial (e.g., universal serial bus (USB)), parallel, or other wired or wireless (e.g., infrared (IR), near field communication (NFC)) connection to communicate with or control one or more peripheral devices (e.g., a printer, card reader).

The mass storage device 1216 may include a machine-readable medium 1222 on which is stored one or more sets of data structures or instructions 1224 (e.g., software) embodying or utilized by any one or more of the techniques or functions described herein. The instructions 1224 may also reside, completely or at least partially, within the main memory 1204, within the static memory 1206, within the hardware processor 1202, or within the GPU 1203 during execution thereof by the machine 1200. In an example, one or any combination of the hardware processor 1202, the GPU 1203, the main memory 1204, the static memory 1206, or the mass storage device 1216 may constitute machine-readable media.

While the machine-readable medium 1222 is illustrated as a single medium, the term “machine-readable medium” may include a single medium, or multiple media, (e.g., a centralized or distributed database, and/or associated caches and servers) configured to store the one or more instructions 1224.

The term “machine-readable medium” may include any medium that is capable of storing, encoding, or carrying instructions 1224 for execution by the machine 1200 and that cause the machine 1200 to perform any one or more of the techniques of the present disclosure, or that is capable of storing, encoding, or carrying data structures used by or associated with such instructions 1224. Non-limiting machine-readable medium examples may include solid-state memories, and optical and magnetic media. In an example, a massed machine-readable medium comprises a machine-readable medium 1222 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks. The instructions 1224 may further be transmitted or received over a communications network 1226 using a transmission medium via the network interface device 1220.

For the purposes of this description the phrases “an online social networking application” and “an online social network system” may be referred to as and used interchangeably with the phrases “an online system,” “an online service,” “a networked system,” or merely “a connections network.” It will also be noted that a connections network may be any type of an online network, such as, e.g., a professional network, an interest-based network, or any online networking system that permits users to join as registered members. For the purposes of this description, registered members of a connections network may be referred to as simply members or users, and some un-registered users may also access the services provided by the online service. As used herein, a “user” refers to any person accessing the service, either registered or unregistered. Further, some connections networks provide services to their members (e.g., search for jobs, search for candidates for jobs, job postings) without being a social network, and the principles presented herein may also be applied to these connection networks.

Each of these non-limiting examples can stand on its own or can be combined in various permutations or combinations with one or more of the other examples. The following examples detail certain aspects of the present subject matter to solve the challenges and provide the benefits discussed herein.

Example 1 can include a computer-implemented method comprising: identifying a training set for training a model; generating a plurality of subqueries based on features associated with the training set; performing a plurality of iterations to create a query template that comprises a subset of the plurality of subqueries, each iteration comprising: performing a search for each subquery based on a disjunction of the subquery and the query template; calculating a precision of each subquery based on the corresponding search results; and adding the subquery with the optimal precision to the query template; receiving a search query from a device of a first user; customizing the query template based on the search query and information of the first user to obtain a search selection query; performing a search utilizing the search selection query; and causing presentation of search results on a display.

In Example 2, the subject matter of Example 1 optionally includes wherein each subquery from the plurality of subqueries comprises a single check or several checks joined by a Boolean AND operation, each check being a condition for a feature being equal to a given value.

In Example 3, the subject matter of any one of Examples 1-2 optionally include wherein adding the subquery with the optimal precision to the query template further comprises: joining with a Boolean OR operation the query template to the subquery with the optimal precision.

In Example 4, the subject matter of any one of Examples 1-3 optionally include wherein performing the search for each subquery comprises: traversing an index of job postings stored in a database of job postings, the index comprising a sorted document list for each value associated with one feature, the traversing comprising: when traversing several checks of features joined by conjunction, traversing together the sorted document lists of the features to find job postings.

In Example 5, the subject matter of Example 4 optionally includes wherein the traversing further comprises: when traversing several checks of features joined by disjunction, adding the sorted document lists for the values of the joined features.

In Example 6, the subject matter of any one of Examples 1-5 optionally include wherein the precision is calculated as number of job postings with job applies in the search results divided by the number of search results.

In Example 7, the subject matter of any one of Examples 1-6 optionally include wherein performing the plurality of iterations further comprises: after adding the subquery with the optimal precision, eliminating the added subquery from consideration in future iterations.

In Example 8, the subject matter of any one of Examples 1-7 optionally include wherein the features in the plurality of subqueries comprise title identifier, skill identifier, seniority identifier, and geographic location identifier.

In Example 9, the subject matter of any one of Examples 1-8 optionally include wherein performing the plurality of iterations further comprises: stopping the iterations after a recall of job applications is complete.

In Example 10, the subject matter of any one of Examples 1-9 optionally include wherein performing the plurality of iterations further comprises: stopping the iterations after a predetermined number of maximum iterations are performed.

Example 11 is a system comprising: a memory comprising instructions; and one or more computer processors, wherein the instructions, when executed by the one or more computer processors, cause the system to perform operations comprising: identifying a training set for training a model; generating a plurality of subqueries based on features associated with the training set; performing a plurality of iterations to create a query template that comprises a subset of the plurality of subqueries, each iteration comprising: performing a search for each subquery based on a disjunction of the subquery and the query template; calculating a precision of each subquery based on the corresponding search results; and adding the subquery with the optimal precision to the query template; receiving a search query from a device of a first user; customizing the query template based on the search query and information of the first user to obtain a search selection query; performing a search utilizing the search selection query; and causing presentation of search results on a display.

In Example 12, the subject matter of Example 11 optionally includes wherein each subquery from the plurality of subqueries comprises a single check or several checks joined by a Boolean AND operation, each check being a condition for a feature being equal to a given value.

In Example 13, the subject matter of any one of Examples 11-12 optionally include wherein adding the subquery with the optimal precision to the query template further comprises: joining with a Boolean OR operation the query template to the subquery with the optimal precision.

In Example 14, the subject matter of any one of Examples 11-13 optionally include wherein performing the search for each subquery comprises: traversing an index of job postings stored in a database of job postings, the index comprising a sorted document list for each value associated with one feature, the traversing comprising: when traversing several checks of features joined by conjunction, traversing together the sorted document lists of the features to find job postings.

In Example 15, the subject matter of any one of Examples 11-14 optionally include wherein the precision is calculated as number of job postings with job applies in the search results divided by the number of search results.

Example 16 is a tangible machine-readable storage medium including instructions that, when executed by a machine, cause the machine to perform operations comprising: identifying a training set for training a model, the training set comprising information on user profiles, job postings, user-entered queries, and job applications submitted on an online service; generating a plurality of subqueries based on features associated with the training set; performing a plurality of iterations to create a query template that comprises a subset of the plurality of subqueries, each iteration comprising: performing a search for each subquery based on a disjunction of the subquery and the query template; calculating a precision of each subquery based on the corresponding search results; and adding the subquery with the optimal precision to the query template; receiving a search query from a device of a first user; customizing the query template based on the search query and information of the first user to obtain a search selection query; performing a search utilizing the search selection query; and causing presentation of search results on a display.

In Example 17, the subject matter of Example 16 optionally includes wherein each subquery from the plurality of subqueries comprises a single check or several checks joined by a Boolean AND operation, each check being a condition for a feature being equal to a given value.

In Example 18, the subject matter of any one of Examples 16-17 optionally include wherein the query template comprises the subset of the plurality of subqueries joined by a Boolean OR operation.

In Example 19, the subject matter of any one of Examples 16-18 optionally include wherein performing the search for each subquery comprises: traversing an index of job postings stored in a database of job postings, the index comprising a sorted document list for each value associated with one feature, the traversing comprising: when traversing several checks of features joined by conjunction, traversing together the sorted document lists of the features to find job postings.

In Example 20, the subject matter of any one of Examples 16-19 optionally include wherein the precision is calculated as number of job postings with job applies in the search results divided by the number of search results.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance, in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
identifying a training set for training a model;
generating a plurality of subqueries based on features associated with the training set;
performing a plurality of iterations to create a query template that comprises a subset of the plurality of subqueries, each iteration comprising:
performing a search for each subquery based on a disjunction of the subquery and the query template;
calculating a precision of each subquery based on the corresponding search results; and
adding the subquery with the highest precision to the query template;
receiving a search query from a device of a first user;
customizing the query template based on the search query and information of the first user to obtain a search selection query;
performing a search utilizing the search selection query; and
causing presentation of search results on a display.

2. The method as recited in claim 1, wherein each subquery from the plurality of subqueries comprises a single check or several checks joined by a Boolean AND operation, each check being a condition for a feature being equal to a given value.

3. The method as recited in claim 1, wherein adding the subquery with the highest precision to the query template further comprises:
joining with a Boolean OR operation the query template to the subquery with the highest precision.

4. The method as recited in claim 1, wherein performing the search for each subquery comprises:
traversing an index of job postings stored in a database of job postings, the index comprising a sorted document list for each value associated with one feature, the traversing comprising:
when traversing several checks of features joined by conjunction, traversing together the sorted document lists of the features to find job postings.

5. The method as recited in claim 4, wherein the traversing further comprises:
when traversing several checks of features joined by disjunction, adding the sorted document lists for the values of the joined features.

6. The method as recited in claim 1, wherein the precision is calculated as number of job postings with job applies in the search results divided by the number of search results.

7. The method as recited in claim 1, wherein performing the plurality of iterations further comprises:
after adding the subquery with the highest precision, eliminating the added subquery from consideration in future iterations.

8. The method as recited in claim 1, wherein the features in the plurality of subqueries comprise title identifier, skill identifier, seniority identifier, and geographic location identifier.

9. The method as recited in claim 1, wherein performing the plurality of iterations further comprises:
stopping the iterations after a recall of job applications is complete.

10. The method as recited in claim 1, wherein performing the plurality of iterations further comprises:
stopping the iterations after a predetermined number of maximum iterations are performed.

11. A system comprising:
a memory comprising instructions; and
one or more computer processors, wherein the instructions, when executed by the one or more computer processors, cause the system to perform operations comprising:
identifying a training set for training a model;
generating a plurality of subqueries based on features associated with the training set;
performing a plurality of iterations to create a query template that comprises a subset of the plurality of subqueries, each iteration comprising:
performing a search for each subquery based on a disjunction of the subquery and the query template;
calculating a precision of each subquery based on the corresponding search results; and
adding the subquery with the highest precision to the query template;
receiving a search query from a device of a first user;
customizing the query template based on the search query and information of the first user to obtain a search selection query;
performing a search utilizing the search selection query; and
causing presentation of search results on a display.

12. The system as recited in claim 11, wherein each subquery from the plurality of subqueries comprises a single check or several checks joined by a Boolean AND operation, each check being a condition for a feature being equal to a given value.

13. The system as recited in claim 11, wherein adding the subquery with the highest precision to the query template further comprises:
joining with a Boolean OR operation the query template to the subquery with the highest precision.

14. The system as recited in claim 11, wherein performing the search for each subquery comprises:
traversing an index of job postings stored in a database of job postings, the index comprising a sorted document list for each value associated with one feature, the traversing comprising:
when traversing several checks of features joined by conjunction, traversing together the sorted document lists of the features to find job postings.

15. The system as recited in claim 11, wherein the precision is calculated as number of job postings with job applies in the search results divided by the number of search results.

16. A tangible machine-readable storage medium including instructions that, when executed by a machine, cause the machine to perform operations comprising:
identifying a training set for training a model, the training set comprising information on user profiles, job postings, user-entered queries, and job applications submitted on an online service;
generating a plurality of subqueries based on features associated with the training set;
performing a plurality of iterations to create a query template that comprises a subset of the plurality of subqueries, each iteration comprising:
performing a search for each subquery based on a disjunction of the subquery and the query template;
calculating a precision of each subquery based on the corresponding search results; and
adding the subquery with the highest precision to the query template;
receiving a search query from a device of a first user;
customizing the query template based on the search query and information of the first user to obtain a search selection query;
performing a search utilizing the search selection query; and
causing presentation of search results on a display.

17. The tangible machine-readable storage medium as recited in claim 16, wherein each subquery from the plurality of subqueries comprises a single check or several checks joined by a Boolean AND operation, each check being a condition for a feature being equal to a given value.

18. The tangible machine-readable storage medium as recited in claim 16, wherein the query template comprises the subset of the plurality of subqueries joined by a Boolean OR operation.

19. The tangible machine-readable storage medium as recited in claim 16, wherein performing the search for each subquery comprises:
traversing an index of job postings stored in a database of job postings, the index comprising a sorted document list for each value associated with one feature, the traversing comprising:
when traversing several checks of features joined by conjunction, traversing together the sorted document lists of the features to find job postings.

20. The tangible machine-readable storage medium as recited in claim 16, wherein the precision is calculated as number of job postings with job applies in the search results divided by the number of search results.
